(19) United States
(12) Patent Application Publication
(10) Pub. No.: US 2018/0075353 A1
(43) Pub. Date: Mar. 15, 2018

(54) METHOD AND SYSTEM FOR COLD START VIDEO RECOMMENDATION

(71) Applicant: SAP SE, Walldorf (DE)

(72) Inventor: Sujoy ROY, Singapore (SG)

(21) Appl. No.: 15/263,385

(22) Filed: Sep. 13, 2016

(51) Int. Cl. G06N 5/02; G06N 99/00

(52) U.S. Cl. CPC G06N 5/022; G06N 99/005

(57) ABSTRACT

Recommending items that have rarely/never been viewed by users is a bottleneck for collaborative filtering (CF) based recommendation algorithms. Previously, item content representation (mostly in textual form) has been used as auxiliary information for learning latent factor representations. Embodiments learn latent factor representation for content items based on modelling an emotional connection between user and content item and based on implicit user feedback regarding the content item.

### BACKGROUND

Matrix Factorization based collaborative filtering approaches are widely used in modern recommender systems. One challenge with this approach is when the collaborative information is very sparse (cold start) and in many cases not available (very cold start scenario). This affects recommendation performance. To address this issue, several methods have been proposed that add content or contextual information as auxiliary information with the collaborative information to show performance improvements. How best to represent the content and contextual information and combine it with the collaborative information has been an ongoing field of investigation.

Therefore, there is a need for an improved framework that addresses the above mentioned challenges.

### SUMMARY

Described is a system, method, and computer-implemented apparatus for recommending items, such as audio, video, documents, web pages, profiles, or other types of media or content. Embodiments are inspired by the observation that users enjoy content because of an emotional connection with it. As such, in one embodiment, emotions evoked by experiencing content are used in combination with implicit user feedback to produce a rank ordering of items. For example, for a set of users and a set of videos, a matrix indicating which users have ‘liked’ which videos and a vector of emotions evoked by each video is used to generate a list of ranked recommendations for one or more of the set of users.

In another embodiment, emotions evoked by experiencing content in combination with implicit user feedback may be used to predict user emotional response to a different piece of content. In yet another embodiment, implicit feedback received from users (e.g., ‘likes’) are a supervisory signal used to improve emotion recognition models. These models can in turn create better recommendations by more accurately identifying emotions contained in content.

These embodiments and more are based on the intuition that latent factors learned from factorizing user-item interaction data carries information that captures the emotive factors of content that makes a user ‘like’ the item.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures, in which like reference numerals designate like parts, and wherein:

FIG. 1 is a block diagram illustrating an exemplary architecture;

FIG. 2 illustrates exemplary equations applicable to rank a set of items for one or more of a set of users;

FIG. 3 illustrates an algorithm that applies, for example, the equations listed in FIG. 2 in order to rank a set of items for one or more of a set of users; and

FIG. 4 is a flow chart illustrating one embodiment of a method for ranking items.

### DETAILED DESCRIPTION

In the following description, for purposes of explanation, specific numbers, materials and configurations are set forth in order to provide a thorough understanding of the present frameworks and methods and in order to meet statutory written description, enablement, and best-mode requirements. However, it will be apparent to one skilled in the art that the present frameworks and methods may be practiced without the specific exemplary details. In other instances, well-known features are omitted or simplified to clarify the description of the exemplary implementations of the present framework and methods, and to thereby better explain the present framework and methods. Furthermore, for ease of understanding, certain method steps are delineated as separate steps; however, these separately delineated steps should not be construed as necessarily order dependent in their performance.

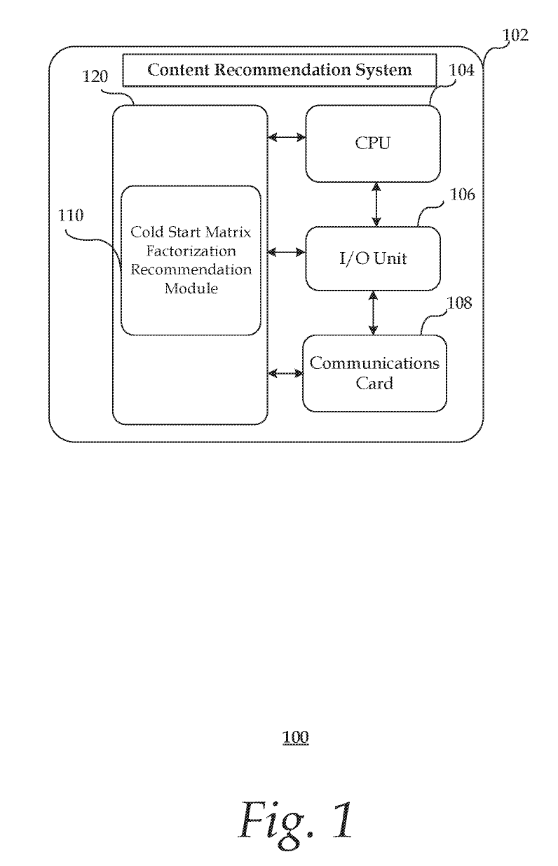

FIG. 1 is a block diagram illustrating an exemplary architecture 100 that may be used to implement ranking items, as described herein. Generally, architecture 100 may include a content recommendation system 102.

The content recommendation system 102 can be any type of computing device capable of responding to and executing instructions in a defined manner, such as a workstation, a server, a portable laptop computer, another portable device, a touch-based tablet, a smart phone, a mini-computer, a mainframe computer, a storage system, a dedicated digital appliance, a device, a component, other equipment, or a combination of these. The system may include a central processing unit (CPU) 104, an input/output (I/O) unit 106, a memory module 120 and a communications card or device 108 (e.g., modem and/or network adapter) for exchanging data with a network (e.g., local area network (LAN) or a wide area network (WAN)). It should be appreciated that the different components and sub-components of the system may be located on different machines or systems. Memory module 120 may include cold start matrix factorization recommendation module 110.

Cold start matrix factorization recommendation module 110 includes logic for receiving and processing a user-item implicit feedback matrix and an emotional-response vector for the purpose of ranking items for a user. Throughout this disclosure, reference is made to “items”. Items contain content. Examples of types of items include audio, video, documents, web pages, profiles, or other media. An “item” refers to the object itself, whereas “content” refers to the material contained within the item. Examples of types of content include sound, motion picture, text, hypertext, social media content, and the like.

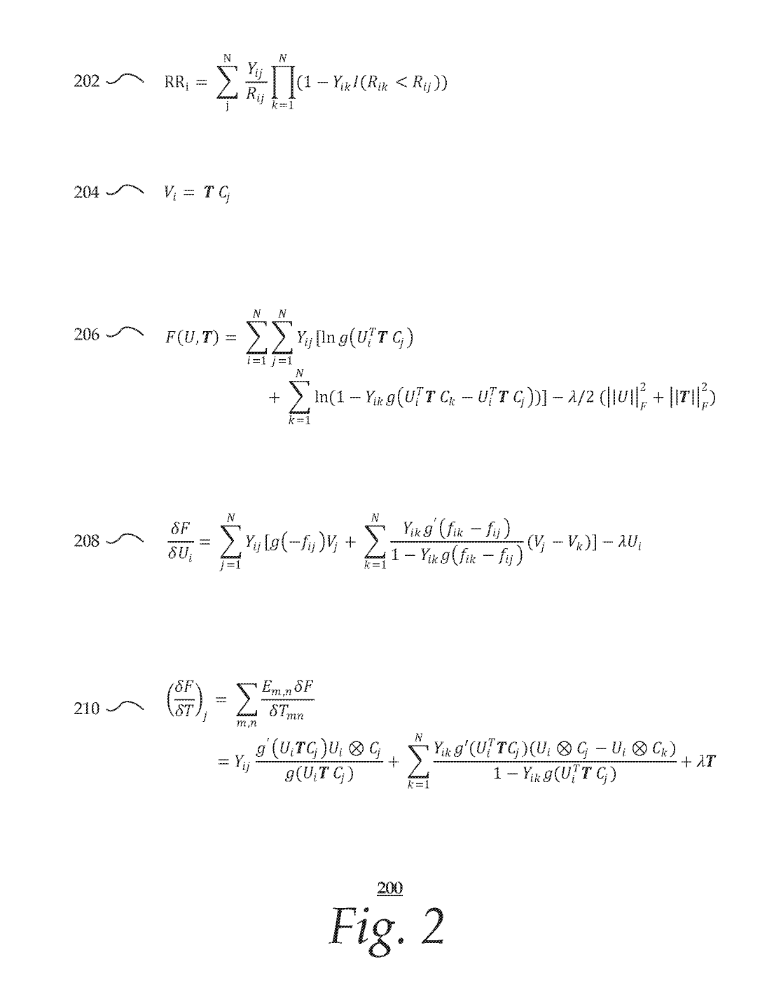

FIG. 2 illustrates exemplary equations 200 applicable to rank a set of items for one or more of a set of users. These equations are but one example of the claimed embodiments, and other techniques are similarly contemplated.

Reciprocal rank equation 202 calculates a reciprocal rank (RR) for user i. Yᵢⱼ denotes the binary relevance score of item j to user i. For example, if item j is relevant to user i else 0. Rᵢⱼ denotes the rank of item j in the ranked list (in descending order) of that item for user i. 1(x) is an indicator function that is equal to 1 if x is true, otherwise 0.

The claimed embodiments generate latent factor representations Uᵢ and Vⱼ for user i and item j, respectively, where Uᵢ is a user vector and Vⱼ is an item vector, and Uᵢ and Vⱼ are factors that when multiplied together result in an M by N relevance matrix. In this context, equation 204 depicts the relationship between item vector Vⱼ, transformation matrix T, and content representation vector Cⱼ, where Vⱼ is an N-dimensional vector, transformation matrix T is an N by N matrix, and Cⱼ is an N-dimensional vector. In one embodiment, each element of vector Cⱼ represents an emotion evoked by content item j. In this way, emotion representations are relatable to the item vector.

Objective function 206 illustrates a function in terms of user vector U and transformation matrix T. In this embodiment, the function g(fᵢⱼ) approximates, and has been substituted for, the 1/Rᵢⱼ term of reciprocal rank equation 202. Similarly, the function g(fᵢₖ−fᵢⱼ) where fᵢⱼ=Uᵢ^{T}Vⱼ approximates and is substituted for the 1(Rᵢₖ<Rᵢⱼ) term of reciprocal rank equation 202. As such, λ is the regularization coefficient, which is an experimentally derived constant for the purpose of ensuring no overfitting. ∥U∥²F is the Frobenius norm of U and ∥T∥ is the Frobenius form of T.

Stochastic gradient ascend is used to maximize the objective function 206. Function 208 depicts one embodiment of a partial derivative of the objective function 206 for user i with respect to Uᵢ. Function 208 is one of two functions used to iteratively calculate user vector U and transformation matrix T by taking partial derivative of the objective function 206.

The other function used to iteratively calculate user vector U and transformation matrix T is function 210, which illustrates the partial derivative of objective function 206, for every user i and item j, with respect to transformation matrix T. E_{m,n} is the elementary matrix of order (m×n), g′(x) is the derivative of g(x) and the circle with an ‘x’ inside is the outer product.

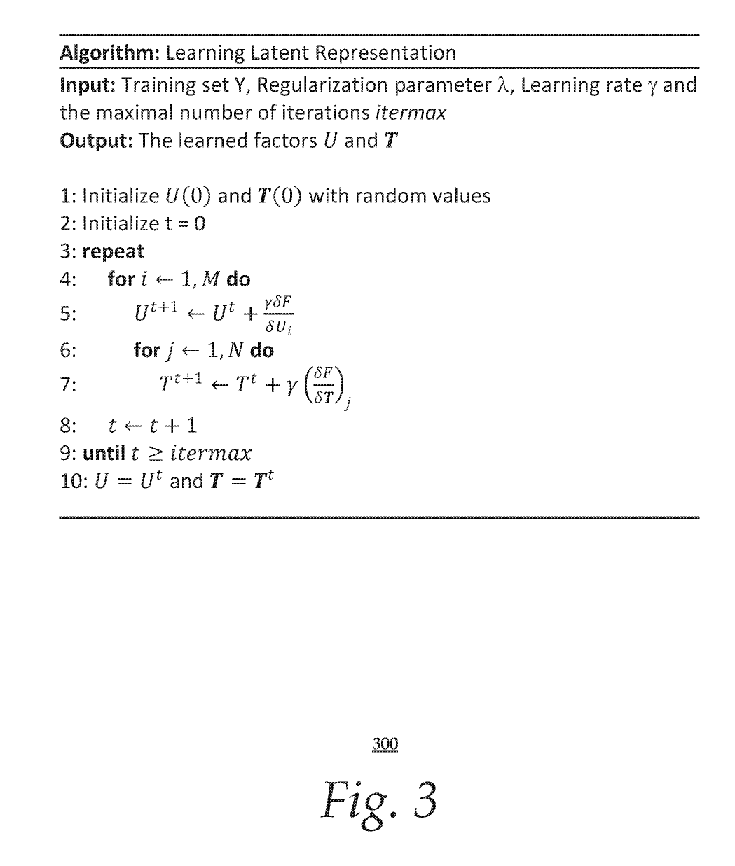

FIG. 3 illustrates an algorithm 300 that applies, in one embodiment, the equations listed in FIG. 2 in order to rank a set of items for one or more of a set of users.

Line 1 initializes user matrix U and transformation matrix T with random values. In one embodiment these are real numbers, i.e., floating point numbers.

Line 2 initializes a counter t to 0. The counter will be incremented at line 8 and tested against itermax at line 9. Line 3 indicates the beginning of a repeated block, lines 4-9.

Line 4 begins the block by executing in a loop, for i equal to 1 to M, the block from lines 5-7. In this block from lines 5-7, line 5 depicts updating the user matrix U by adding the previous value to equation 208 multiplied by a learning rate y, where equation 208 includes the partial derivative of objective function 206 with respect to user vector Uᵢ. The purpose of the learning rate γ is to ensure convergence. Line 6 depicts an inner loop, from j equals 1 to N, executing line 7, which updates transformation matrix T by adding the result of equation 210 multiplied by the learning rate γ, where equation 210 represents a partial derivative of the objective function 206 with respect to the transformation matrix T.

At line 10, the final latent factor matrices U and T are returned as output.

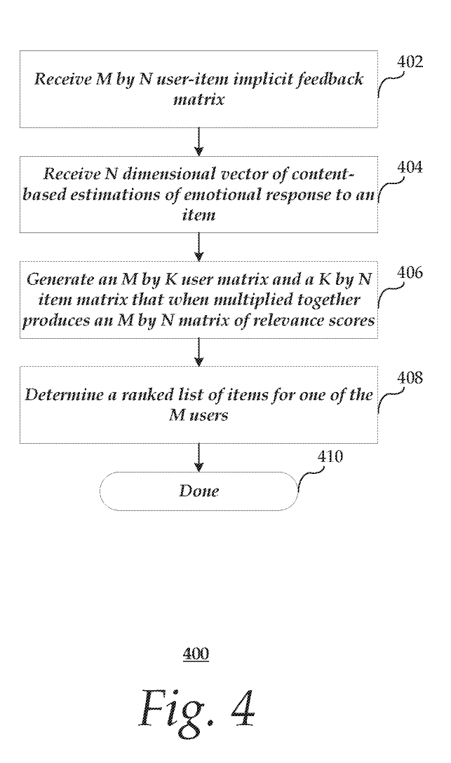

FIG. 4 is a flow chart 400 illustrating one embodiment of a method for ranking items. At block 402, an M by N user-item implicit feedback matrix is received. Each row of the user-item matrix represents a user, while each column represents an item. Items may be, for example, videos, photos, text, audio clips, documents, web pages, social media profiles, or other sources of content. In one embodiment, implicit feedback is derived from an indication, behavior, action, etc., that manifests some experience or affinity for an item. This information may be generated as a matter of course as a user browses an online shopping listing, streaming video catalogue, or other source of content, as a user may click on a ‘like’ button, play a piece of content long enough to consider it ‘viewed’ (in absolute terms or as a percentage of the content length) or perform another action that is not an express ranking but which gives an indication of affinity with a piece of content.

In one embodiment, the implicit feedback includes a unary indication that a user ‘liked’ an item—e.g., the user click on the ‘Like’ button on Facebook®. User-item combinations for which no ‘like’ has been recorded are undefined. However, binary, ternary, or any other representation of implicit feedback is similarly contemplated. In some embodiments, some or all items may be ‘undefined’ for a given user. It is an object of the invention to generate a ranked recommendation of items for a user, regardless of how many (including none) of the items the user has implicit feedback for.

At block 404 an N dimensional vector of content-based estimations of emotional responses to items is received. Emotion modeling refers to the problem of automatically estimating the expected emotional response that a content will receive from users. Many techniques have been used for emotion modeling, any and all of which are contemplated for the claimed embodiments. In one embodiment, automatically estimating an expected emotional response includes representing each item by a feature representation that carries emotional information. Affective features, sentibank features, hybrid convolutional neural networks (CNN) features, and the like are examples of feature representations that carry emotional information. In the case of video, these features are based on visual content of the item (e.g. not a text description of the item, review of the item, etc.). In one embodiment, emotion categories, also called labels, are given to each item based on the feature representation. Videos may be labeled with one or more emotional categories, such as Amusement, Anger, Disgust, Fear, Interest, Joy, Sadness, Surprise, and Tension. In one embodiment, real numbers are used to value the emotions, but integers, whole numbers, tuples, or any other representation is similarly contemplated. In one embodiment, the real numbers are derived from a syntactic structure of the corresponding item. Other types of items are similarly capable of being associated with emotion labels. While emotion labels are predicted from pixels of an image or video, they may be predicted from characters or words from text, an audio waveform from an audio item, etc.

At block 406, an M by N matrix of relevance scores is generated based on the N dimensional vector of estimated emotional responses and the received M by N matrix of implicit feedback. In one embodiment, an M by K user matrix and a K by N item matrix are generated, such that when multiplied together, produce an M by N matrix of relevance scores. In this way, the M by K user matrix and the K by N item matrix are latent factor representations of the M by N user-item relevance matrix.

Typically, the M by N matrix of relevance scores contains a value for each combination of user and item (i.e., is dense), in contrast to the M by N matrix of implicit feedback, which may be sparse. Relevance scores may be binary values, integers, or any other representation. Relevance scores are distinct from implicit feedback in that implicit feedback represents some user actions, typically not explicit rankings, whereas relevance scores are one result of the claimed embodiments.

In one embodiment, the K by N item matrix is generated indirectly by generating an N by N transformation matrix, that, when multiplied by the N dimensional vector of estimated emotional responses, generates the K by N item matrix. One example of this is equation 204 of FIG. 2.

In one embodiment, the M by K user matrix and the N by N transformation matrix are generated by random seeding and iterative updating based on an objective function, such as function 206 of FIG. 2. The objective function 206 is defined in terms of user matrix U (the M by N user matrix) and transformation matrix T (the N by N transformation matrix). The M by K user matrix and the N by N transformation matrix are, in one embodiment, updated by adding the result of the previous iteration to the partial derivative of the objective function. Specifically, the M by K user matrix U is updated by adding the partial derivative of the objective function with respect to U (function 208 of FIG. 2) to the previous iteration of U. Similarly, the N by N transformation matrix T is updated by adding the partial derivative of the objective function with respect to T (function 210 of FIG. 2) to the previous iteration of T. A more detailed description of this process is described above with regard to FIG. 3.

At block 408, a ranked list of items for one of the M users is generated. In one embodiment, the ranking is based on the reciprocal rank function 202 as described above with regard to FIG. 2. In one embodiment the reciprocal rank of each item is calculated for a given user, and sorted in descending order to produce the ranked list of items.

At block 410, the process 400 ends.

1. A computer-implemented method for ranking items, comprising:
receiving an M by N matrix, wherein each of the M rows represents a user and each of the N columns represents an item, wherein each entry in the matrix represents implicit feedback given by one of the M users with regard to one of the N items, and wherein at least one entry in the matrix is undefined;
receiving an N dimensional vector, wherein each entry represents a content-based estimation of an emotional response that one of the N items evokes;
generating, based on the N dimensional vector of estimated emotional responses and the received M by N matrix of implicit feedback, an M by K user matrix and a K by N item matrix that, when multiplied together, produces an M by N matrix of relevance scores, wherein each relevance score defines a relevance of one of the N items to one of the M users; and
determining, for one of the M users, a ranked-list of item recommendations based on the generated M by K user matrix and the generated K by N item matrix.

2. The computer-implemented method of claim 1, wherein generating the K by N item matrix includes generating an N by N transformation matrix that when multiplied by the N dimensional vector of estimated emotional responses generates the K by N item matrix.

3. The computer-implemented method of claim 2, wherein generating the M by K user matrix and N by N transformation matrix includes:
randomly seeding values of the M by K user matrix and the N by N transformation matrix; and
iteratively updating the M by K user matrix and the N by N transformation matrix based on minimizing an objective function, wherein the objective function is based on the N dimensional vector of estimated emotional responses and the received M by N matrix of implicit feedback.

4. The computer-implemented method of claim 3, wherein the objective function is defined in terms of the M by K user matrix and the N by N transformation matrix, and wherein iteratively updating the M by K user matrix and the N by N transformation matrix includes:
repeating, until a number of iterations has been reached or a convergence has been detected:
for each of the M users:
set the M by K user matrix to a sum of the M by K user matrix and a partial derivative of the objective function taken with respect to the M by K user matrix, and,
for each of the N items, set the N by N transformation matrix to the sum of the N by N transformation matrix and a partial derivative of the objective function taken with respect to the N by N transformation matrix.

5. The computer-implemented method of claim 3, wherein the objective function is based on maximizing a mean reciprocal rank function, wherein the mean reciprocal rank function orders items based on relevance to the user.

6. The computer-implemented method of claim 1, wherein the implicit feedback given by the one of the M users with regard to the one of the N items comprises a unary implicit feedback.

7. The computer-implemented method of claim 6, wherein the unary implicit feedback includes an indication that the item was liked, an indication that the item was experienced, an indication that the item was experienced for a defined amount of time, or an indication that the item was experienced for a defined percentage of time.

8. The computer-implemented method of claim 1, wherein the item is a video, photo, audio, or text.

9. The computer-implemented method of claim 1, wherein all items of at least one column of the received M by N matrix are undefined.

10. The computer-implemented method of claim 1, wherein each entry of the N-dimensional vector of estimated emotional responses comprises a real number value.

11. The computer-implemented method of claim 10, wherein each of the real number values is derived from a syntactic structure of the corresponding item.

12. The computer-implemented method of claim 11, wherein for an image or video item, the syntactic structure comprises pixels, wherein for a text item the syntactic structure comprises characters or words, and wherein for an audio item the syntactic structure comprises an audio waveform.

13. The computer-implemented method of claim 1, wherein the ranked-list of item recommendations is further based on implicit feedback of other M users.

14. A computing apparatus for ranking items, the computing apparatus comprising:
a processor; and
a memory storing instructions that, when executed by the processor, configures the apparatus to:
receive an M by N matrix, wherein each of the M rows represents a user and each of the N columns represents an item, wherein each entry in the matrix represents implicit feedback given by one of the M users with regard to one of the N items, and wherein at least one entry in the matrix is undefined,
receive an N dimensional vector, wherein each entry represents a content-based estimation of an emotional response that one of the N items evokes,
generate, based on the N dimensional vector of estimated emotional responses and the received M by N matrix of implicit feedback, an M by K user matrix and a K by N item matrix that, when multiplied together, produces an M by N matrix of relevance scores, wherein each relevance score defines a relevance of one of the N items to one of the M users, and
determine, for one of the M users, a ranked-list of item recommendations based on the generated M by K user matrix and the generated K by N item matrix.

15. The computer-implemented method of claim 14, wherein generating the K by N item matrix includes generating an N by N transformation matrix that when multiplied by the N dimensional vector of estimated emotional responses generates the K by N item matrix.

16. The computer-implemented method of claim 15, wherein generating the M by K user matrix and N by N transformation matrix includes:
randomly seeding values of the M by K user matrix and the N by N transformation matrix; and
iteratively updating the M by K user matrix and the N by N transformation matrix based on minimizing an objective function, wherein the objective function is based on the N dimensional vector of estimated emotional responses and the received M by N matrix of implicit feedback.

17. The computer-implemented method of claim 16, wherein the objective function is defined in terms of the M by K user matrix and the N by N transformation matrix, and wherein iteratively updating the M by K user matrix and the N by N transformation matrix includes:
repeating, until a number of iterations has been reached or a convergence has been detected:
for each of the M users:
set the M by K user matrix to a sum of the M by K user matrix and a partial derivative of the objective function taken with respect to the M by K user matrix, and,
for each of the N items, set the N by N transformation matrix to the sum of the N by N transformation matrix and a partial derivative of the objective function taken with respect to the N by N transformation matrix.

18. The computer-implemented method of claim 17, wherein the M by K user matrix and the K by N item matrix comprise latent factor representations of an M by N user-item relevance matrix.

19. The computer-implemented method of claim 18, wherein the ranked-list of item recommendations for the user is determined based on sorting, in descending order, for each row of the K by N item matrix, a dot product of a column of the M by K user matrix that corresponds to the user with the row of the K by N item matrix.

20. A non-transitory computer-readable storage medium for ranking items, the computer-readable storage medium including instructions that when executed by a computer, cause the computer to:
receive an M by N matrix, wherein each of the M rows represents a user and each of the N columns represents an item, wherein each entry in the matrix represents implicit feedback given by one of the M users with regard to one of the N items, and wherein at least one entry in the matrix is undefined;
receive an N dimensional vector, wherein each entry represents a content-based estimation of an emotional response that one of the N items evokes;
generate, based on the N dimensional vector of estimated emotional responses and the received M by N matrix of implicit feedback, an M by K user matrix and a K by N item matrix that, when multiplied together, produces an M by N matrix of relevance scores, wherein each relevance score defines a relevance of one of the N items to one of the M users; and
determine, for one of the M users, a ranked-list of item recommendations based on the generated M by K user matrix and the generated K by N item matrix.
